(19) United States
(12) Patent Application Publication
(10) Pub. No.: US 2019/0210345 A1
(43) Pub. Date: Jul. 11, 2019

(54) Graphene Paper Having High Through-Plane Conductivity and Production Process

(71) Applicant: Nanotek Instruments, Inc., Dayton, OH (US)

(72) Inventors: Yi-jun Lin, Taoyuan City (TW); Aruna Zhamu, Springboro, OH (US); Bor Z. Jang, Centerville, OH (US)

(73) Assignee: Nanotek Instruments, Inc., Dayton, OH (US)

(21) Appl. No.: 15/864,991

(22) Filed: Jan. 8, 2018

(51) Int. Cl. B32B 37/00; H01M 4/66; H01M 8/0245; B32B 7/14; H01M 8/0234; H01M 8/0232; B32B 9/00; C01B 32/194; F28F 21/02

(52) U.S. Cl. CPC B32B 37/0084; C01B 2204/22; H01M 8/0245; B32B 7/14; H01M 4/663; H01M 4/661; H01M 8/0234; H01M 8/0232; B32B 9/007; C01B 32/194; F28F 21/02; B32B 2457/18; B32B 2457/10; B32B 2307/302; B32B 2307/202; B32B 2313/04; C01B 2204/24; H01M 4/667

(57) ABSTRACT

A process for producing a graphene paper product of metal-bonded graphene sheets, comprising: (a) preparing a graphene dispersion having discrete graphene sheets dispersed in a fluid medium, wherein the graphene sheets contain single-layer or few-layer graphene sheets selected from a pristine graphene material or a non-pristine graphene material, wherein the non-pristine graphene is selected from graphene oxide, reduced graphene oxide, graphene fluoride, graphene chloride, graphene bromide, graphene iodide, hydrogenated graphene, nitrogenated graphene, doped graphene, chemically functionalized graphene, or a combination thereof; (b) assembling the graphene sheets into a paper product containing a sheet or a roll of graphene paper; and (c) depositing a metal on surfaces of graphene sheets to bond graphene sheets together for forming the graphene paper product, which contains off-plane graphene sheets.

### FIELD OF THE INVENTION

The present disclosure relates generally to the field of graphene materials and, more particularly, to a highly conductive paper composed of metal-bonded graphene sheets and having off-plane graphene sheets.

### BACKGROUND OF THE INVENTION

Carbon is known to have five unique crystalline structures, including diamond, fullerene (0-D nano graphitic material), carbon nanotube or carbon nanofiber (1-D nano graphitic material), graphene (2-D nano graphitic material), and graphite (3-D graphitic material). The carbon nanotube (CNT) refers to a tubular structure grown with a single wall or multi-wall. Carbon nanotubes (CNTs) and carbon nanofibers (CNFs) have a diameter on the order of a few nanometers to a few hundred nanometers. Their longitudinal, hollow structures impart unique mechanical, electrical and chemical properties to the material. The CNT or CNF is a one-dimensional nanocarbon or 1-D nano graphite material.

Bulk natural graphite is a 3-D graphitic material with each graphite particle being composed of multiple grains (a grain being a graphite single crystal or crystallite) with grain boundaries (amorphous or defect zones) demarcating neighboring graphite single crystals. Each grain is composed of multiple graphene planes that are oriented parallel to one another. A graphene plane in a graphite crystallite is composed of carbon atoms occupying a two-dimensional, hexagonal lattice. In a given grain or single crystal, the graphene planes are stacked and bonded via van der Waal forces in the crystallographic c-direction (perpendicular to the graphene plane or basal plane). Although all the graphene planes in one grain are parallel to one another, typically the graphene planes in one grain and the graphene planes in an adjacent grain are inclined at different orientations. In other words, the orientations of the various grains in a graphite particle typically differ from one grain to another.

A graphite single crystal (crystallite) per se is anisotropic with a property measured along a direction in the basal plane (crystallographic a- or b-axis direction) being dramatically different than if measured along the crystallographic c-axis direction (thickness direction). For instance, the thermal conductivity of a graphite single crystal can be up to approximately 1,920 W/mK (theoretical) or 1,800 W/mK (experimental) in the basal plane (crystallographic a- and b-axis directions), but that along the crystallographic c-axis direction is less than 10 W/mK (typically less than 5 W/mK). Further, the multiple grains or crystallites in a graphite particle are typically all oriented along different and random directions. Consequently, a natural graphite particle composed of multiple grains of different orientations exhibits an average property between these two extremes (i.e. between 5 W/mK and 1,800 W/mK).

The constituent graphene planes of a graphite crystallite in a natural or artificial graphite particle can be exfoliated and extracted or isolated to obtain individual graphene sheets of carbon atoms provided the inter-planar van der Waals forces can be overcome. An isolated, individual graphene sheet of carbon atoms is commonly referred to as single-layer graphene. A stack of multiple graphene planes bonded through van der Waals forces in the thickness direction with an inter-graphene plane spacing of approximately 0.3354 nm is commonly referred to as a multi-layer graphene. A multi-layer graphene platelet has up to 300 layers of graphene planes (<100 nm in thickness), but more typically up to 30 graphene planes (<10 nm in thickness), even more typically up to 20 graphene planes (<7 nm in thickness), and most typically up to 10 graphene planes (commonly referred to as few-layer graphene in scientific community). Single-layer graphene and multi-layer graphene sheets are collectively called “nano graphene platelets” (NGPs). Graphene or graphene oxide sheets/platelets (collectively, NGPs) are a new class of carbon nano material (a 2-D nanocarbon) that is distinct from the 0-D fullerene, the 1-D CNT, and the 3-D graphite.

Our research group pioneered the development of graphene materials and related production processes as early as 2002: (1) B. Z. Jang and W. C. Huang, “Nano-scaled Graphene Plates,” U.S. Pat. No. 7,071,258 (Jul. 4, 2006), application submitted on Oct. 21, 2002; (2) B. Z. Jang, et al. “Process for Producing Nano-scaled Graphene Plates,” U.S. patent application Ser. No. 10/858,814 (Jun. 3, 2004) (U.S. Patent Pub. No. 2005/0271574); and (3) B. Z. Jang, A. Zhamu, and J. Guo, “Process for Producing Nano-scaled Platelets and Nanocomposites,” U.S. patent application Ser. No. 11/509,424 (Aug. 25, 2006) (U.S. Pat. Pub. No. 2008-0048152).

NGPs are typically obtained by intercalating natural graphite particles with a strong acid and/or oxidizing agent to obtain a graphite intercalation compound (GIC) or graphite oxide (GO), as illustrated in FIG. 1(A) (process flow chart) and FIG. 1(B) (schematic drawing). The presence of chemical species or functional groups in the interstitial spaces between graphene planes serves to increase the inter-graphene spacing (d₀₀₂, as determined by X-ray diffraction), thereby significantly reducing the van der Waals forces that otherwise hold graphene planes together along the c-axis direction. The GIC or GO is most often produced by immersing natural graphite powder (20 in FIG. 1(A) and 100 in FIG. 1(B)) in a mixture of sulfuric acid, nitric acid (an oxidizing agent), and another oxidizing agent (e.g. potassium permanganate or sodium perchlorate). The resulting GIC (22 or 102) is actually some type of graphite oxide (GO) particles. This GIC or GO is then repeatedly washed and rinsed in water to remove excess acids, resulting in a graphite oxide suspension or dispersion, which contains discrete and visually discernible graphite oxide particles dispersed in water. There are two processing routes to follow after this rinsing step:

Route 1 involves removing water from the suspension to obtain “expandable graphite,” which is essentially a mass of dried GIC or dried graphite oxide particles. Upon exposure of expandable graphite to a temperature in the range of typically 800-1,050° C. for approximately 30 seconds to 2 minutes, the GIC undergoes a rapid volume expansion by a factor of 30-300 to form “graphite worms” (24 or 104), which are each a collection of exfoliated, but largely un-separated graphite flakes that remain interconnected.

In Route 1A, these graphite worms (exfoliated graphite or “networks of interconnected/non-separated graphite flakes”) can be re-compressed to obtain flexible graphite sheets or foils (26 or 106) that typically have a thickness in the range of 0.1 mm (100 μm)-0.5 mm (500 μm). Alternatively, one may choose to use a low-intensity air mill or shearing machine to simply break up the graphite worms for the purpose of producing the so-called “expanded graphite flakes” (108) which contain mostly graphite flakes or platelets thicker than 100 nm (hence, not a nano material by definition).

Exfoliated graphite worms, expanded graphite flakes, and the recompressed mass of graphite worms (commonly referred to as flexible graphite sheet or flexible graphite foil) are all 3-D graphitic materials that are fundamentally different and patently distinct from either the 1-D nanocarbon material (CNT or CNF) or the 2-D nanocarbon material (graphene sheets or platelets, NGPs). Flexible graphite (FG) foils can be used as a heat spreader material, but exhibiting a maximum in-plane thermal conductivity of typically less than 500 W/mK (more typically <300 W/mK) and in-plane electrical conductivity no greater than 1,500 S/cm. These low conductivity values are a direct result of the many defects, wrinkled or folded graphite flakes, and interruptions or gaps between graphite flakes,

In Route 1B, the exfoliated graphite is subjected to high-intensity mechanical shearing (e.g. using an ultrasonicator, high-shear mixer, high-intensity air jet mill, or high-energy ball mill) to form separated single-layer and multi-layer graphene sheets (collectively called NGPs, 33 or 112), as disclosed in our U.S. application Ser. No. 10/858,814. Single-layer graphene can be as thin as 0.34 nm, while multi-layer graphene can have a thickness up to 100 nm, but more typically less than 20 nm.

Route 2 entails ultrasonicating the graphite oxide suspension for the purpose of separating/isolating individual graphene oxide sheets from graphite oxide particles. This is based on the notion that the inter-graphene plane separation has been increased from 0.3354 nm in natural graphite to 0.6-1.1 nm in highly oxidized graphite oxide, significantly weakening the van der Waals forces that hold neighboring planes together. Ultrasonic power can be sufficient to further separate graphene plane sheets to form separated, isolated, or discrete graphene oxide (GO) sheets. These graphene oxide sheets can then be chemically or thermally reduced to obtain “reduced graphene oxides” (RGO) typically having an oxygen content of 0.001%-10% by weight, more typically 0.01%-5% by weight, most typically and preferably less than 2% by weight.

For the purpose of defining the claims of the instant application, NGPs include discrete sheets/platelets of single-layer and multi-layer pristine graphene, graphene oxide, or reduced graphene oxide (RGO). Pristine graphene has essentially 0% oxygen. RGO typically has an oxygen content of 0.001%-5% by weight. Graphene oxide (including RGO) can have 0.001%-50% by weight of oxygen.

NGPs (including discrete sheets/platelets of pristine graphene, GO, and RGO), when packed into a film, membrane, or paper sheet (34 or 114 in FIG. 1(A) or 1(B)) of non-woven aggregates using a paper-making process, typically do not exhibit a high thermal conductivity. In general, a paper-like structure or mat made from platelets of graphene, GO, or RGO (e.g. those paper sheets prepared by vacuum-assisted filtration process) exhibit many defects, wrinkled or folded graphene sheets, interruptions or gaps between platelets, and non-parallel platelets (e.g. FIG. 2), leading to relatively poor thermal conductivity and low electric conductivity (both in-plane and through-plane conductivities), and low structural strength. These papers or aggregates of discrete NGP, GO or RGO platelets alone (without a resin binder) also have a tendency to get flaky, emitting conductive particles into air.

Thus, it is an object of the present disclosure to provide a cost-effective process for producing graphene paper sheet which exhibits a high thermal conductivity, electrical conductivity, and tensile strength. It is another object of the present disclosure to provide a graphene-based paper for use as a heat dissipation or heat spreading element in a smart phone, tablet computer, digital camera, display device, flat-panel TV, LED lighting device, etc. Such a sheet of graphene paper should exhibit a high thermal conductivity and high electrical conductivity not just along the in-plane directions, but also in the through-plane direction (thickness-direction).

### SUMMARY OF THE INVENTION

The present disclosure provides a graphene paper product of metal-bonded graphene sheets. This disclosure also provides a process for producing such a conductive paper. The thickness of this paper product can be from 5 nm to 500 μm (can be even thicker; e.g. up to 5 mm), but more typically from 10 nm to 500 μm, and further more typically from 100 nm to 200 μm. The present disclosure also provides a process for producing such a conductive graphene paper.

The process comprises: (a) preparing a graphene dispersion having discrete graphene sheets dispersed in a fluid medium, wherein the graphene sheets contain single-layer or few-layer graphene sheets selected from a pristine graphene material or a non-pristine graphene material, wherein said non-pristine graphene is selected from graphene oxide, reduced graphene oxide, graphene fluoride, graphene chloride, graphene bromide, graphene iodide, hydrogenated graphene, nitrogenated graphene, doped graphene, chemically functionalized graphene, or a combination thereof; (b) assembling the graphene sheets into a sheet or a roll of graphene paper having a paper sheet plane, a thickness direction perpendicular to this paper sheet plane, multiple pores between graphene sheets and a number of graphene sheets being inclined at an angle of 15-90 degrees relative to this paper sheet plan and (c) depositing a bonding metal on surfaces of the graphene sheets or into the pores between graphene sheets to bond graphene sheets together for forming the graphene paper product.

The step of depositing the bonding metal is preferably conducted chemically, electrochemically or electrolytically. More preferably, the step of depositing a bonding metal includes chemical deposition (including electroless plating), electrochemical deposition (including electro-plating), electrolytical deposition, or a combination thereof.

Preferably and typically, the graphene paper product prepared by this process has a through-plane or thickness-direction thermal conductivity from 10 to 800 W/mK or a thickness-direction electrical conductivity from 40 S/cm to 3,200 S/cm.

In certain embodiments, the process may further comprise a step (d) of mechanically compressing or consolidating said graphene paper product. This step (d) is preferably taken after step (c).

The graphene dispersion in step (a) may further contain particles or fibrils of a metal, carbon or graphite filler selected from a carbon or graphite fiber, carbon or graphite nanofiber, carbon nanotube, carbon nanorod, mesophase carbon particle, mesocarbon microbead, expanded graphite flake (having a thickness greater than 100 nm), needle coke, carbon black or acetylene black, activated carbon, or a combination thereof and the metal filler is selected from Ti, V, Cr, Mn, Fe, Co, Ni, Cu, Zn, Zr, Mo, Pd, Ag, Cd, Au, Pt, W, Al, Sn, In, Pb, Bi, an alloy thereof, or a mixture thereof, wherein the filler metal-, carbon-, or graphite-to-graphene ratio is from 1/100 to 1/1. The filler induces orientation of some graphene sheets out of a paper sheet plane (inclined at an angle of 15-90 degrees relative to the paper sheet plane), imparting high through-plane or thickness-direction thermal conductivity and electrical conductivity to the paper product.

In the invented process, the bonding metal is preferably selected from Ti, V, Cr, Mn, Fe, Co, Ni, Cu, Zn, Zr, Mo, Pd, Ag, Cd, Au, Pt, W, Al, Sn, In, Pb, Bi, an alloy thereof, or a mixture thereof. Preferably, the metal occupies a weight fraction of 0.1%-95% based on the total paper product weight, more preferably a weight fraction of 1%-50%. In certain embodiments, the metal bonds the graphene sheets at least in an end-to-end manner, or the metal fills into pores of said paper product.

The process may further comprise, between step (b) and step (c), a heat treatment at a temperature from 80 to 1,500° C. to at least partially remove non-carbon elements in the graphene sheets, wherein removal of the non-carbon elements induces orientation of some graphene sheets out of a paper sheet plane (inclined at an angle of 15-90 degrees relative to the paper sheet plane). The off-the-plane graphene sheets impart high through-plane or thickness-direction thermal conductivity and electrical conductivity to the paper product.

The heat treatment temperature may contain a temperature from 500° C. to 1,500° C. and the graphene paper product has a thickness-direction thermal conductivity from 20 W/mK to 800 W/mK or a thickness-direction electrical conductivity from 80 S/cm to 3,200 S/cm.

The step of depositing metal may include an operation of electrochemical plating, pulse power deposition, solution deposition, electrophoretic deposition, electroless plating, chemical deposition, or a combination thereof.

Without such a metal deposition step, the resulting paper can exhibit some degree of thickness direction and, hence, some good thickness-direction thermal conductivity and electrical conductivity although not as high as those of a paper product having a bonding metal. Thus, this disclosure also provides process for producing a graphene paper product having a high thickness-direction conductivity; the process comprising: (a) preparing a graphene dispersion having discrete graphene sheets dispersed in a fluid medium, wherein said graphene sheets contain single-layer or few-layer graphene sheets selected from a pristine graphene material or a non-pristine graphene material, wherein the non-pristine graphene is selected from graphene oxide, reduced graphene oxide, graphene fluoride, graphene chloride, graphene bromide, graphene iodide, hydrogenated graphene, nitrogenated graphene, doped graphene, chemically functionalized graphene, or a combination thereof; and (b) assembling the graphene sheets into a sheet or a roll of graphene paper (e.g. using a paper-making procedure), having a paper sheet plane and a thickness direction perpendicular to the paper sheet plane, and heat treating the sheet or roll of graphene paper at a temperature from 80° C. to 1,500° C. to at least partially remove non-carbon elements in the graphene sheets, wherein removal of the non-carbon elements induces orientation of graphene sheets out of a paper sheet plane which are inclined at an angle of 15-90 degrees relative to said paper sheet plane in such a manner that the graphene paper product has a thickness-direction thermal conductivity from 10 to 200 W/mK or a thickness-direction electrical conductivity from 40 S/cm to 800 S/cm.

The process may further comprise a step of heat treating the sheet or roll of graphene paper at a second temperature from 1,500° C. to 3,200° C.

In this process, the graphene dispersion contains particles or fibrils of a metal, carbon or graphite filler to induce orientation of said graphene sheets inclined at an angle of 15-90 degrees relative to said paper sheet plane, wherein said carbon or graphite filler is selected from a carbon or graphite fiber, carbon or graphite nanofiber, carbon nanotube, carbon nanorod, mesophase carbon particle, mesocarbon microbead, expanded graphite flake, needle coke, carbon black or acetylene black, activated carbon, or a combination thereof, and the metal filler is selected from Ti, V, Cr, Mn, Fe, Co, Ni, Cu, Zn, Zr, Mo, Pd, Ag, Cd, Au, Pt, W, Al, Sn, In, Pb, Bi, an alloy thereof, or a mixture thereof and wherein said metal-, carbon-, or graphite-to-graphene ratio is from 1/100 to 1/1. In some embodiments, there is no additional bonding metal (only the metal filler being present).

The graphene sheets in the graphene dispersion occupy a weight fraction of 0.1% to 25% (preferably 3% to 15%) based on the total weight of graphene sheets and liquid medium combined.

The graphene paper product typically has a thickness from 10 nm to 500 μm, preferably from 100 nm to 200 μm.

The present disclosure provides a graphene paper product of metal-bonded graphene sheets produced by a process as defined above. The paper product comprises (i) a sheet or a roll of graphene paper having graphene sheets and pores between graphene sheets and (ii) a metal that fills in the pores or bonds the graphene sheets together, wherein the graphene sheets contain single-layer or few-layer graphene sheets selected from a pristine graphene material or a non-pristine graphene material, wherein the non-pristine graphene is selected from graphene oxide, reduced graphene oxide, graphene fluoride, graphene chloride, graphene bromide, graphene iodide, hydrogenated graphene, nitrogenated graphene, doped graphene, chemically functionalized graphene, or a combination thereof. The graphene paper product has a through-plane (thickness-direction) thermal conductivity from 10 W/mK to 800 W/mK or a thickness-direction electrical conductivity from 40 S/cm to 3,200 S/cm.

The graphene paper product may further comprise particles or fibrils of a carbon or graphite filler disposed between graphene sheets and selected from a carbon or graphite fiber, carbon or graphite nanofiber, carbon nanotube, carbon nanorod, mesophase carbon particle, mesocarbon microbead, expanded graphite flake (having a thickness greater than 100 nm), needle coke, carbon black or acetylene black, activated carbon, or a combination thereof, wherein the carbon or graphite-to-graphene ratio is preferably from 1/100 to 1/1

This disclosure also provides a thermal management device containing the invented graphene paper product. This disclosure also provides a heat dissipation or heat spreading element containing the aforementioned graphene paper product, wherein the element is disposed in a smart phone, tablet computer, digital camera, display device, flat-panel TV, or LED lighting device

The present disclosure further provides a fuel cell bipolar plate containing the graphene paper product. Additionally, this disclosure provides a battery current collector containing the graphene paper product.

### BRIEF DESCRIPTION OF THE DRAWINGS

FIG. 1(A) A flow chart illustrating various prior art processes of producing exfoliated graphite products (flexible graphite foils and flexible graphite composites) and pyrolytic graphite (bottom portion), along with a process for producing graphene oxide gel or GO dispersion.

FIG. 1(B) Schematic drawing illustrating the processes for producing conventional paper, mat, film, and membrane of simply aggregated graphite or NGP flakes/platelets. All processes begin with intercalation and/or oxidation treatment of graphitic materials (e.g. natural graphite particles).

FIG. 2 A SEM image of a cross-section of a conventional graphene paper (RGO) prepared from discrete graphene sheets/platelets using a paper-making process (e.g. vacuum-assisted filtration).

FIG. 3 In-plane and through-plane electrical conductivity values of the GO-derived graphene sheets (prepared by Comma coating, heat treatment, and compression), with or without off-plane graphene sheets. All bonded with 10% Cu.

FIG. 4 In-plane and through-plane electrical conductivity values of RGO paper sheets (all having some off-plane graphene sheets), with or without bonding Cu.

FIG. 5 The through-plane electrical conductivity of graphene paper having some off-plane graphene sheets, its Sn-bonded counterpart (3% Sn by wt.), and theoretical predictions based on a rule-of-mixture law, all plotted as a function of the final heat treatment temperature.

FIG. 6 Through-plane thermal conductivity values of graphene fluoride paper bonded by Cu and those of nitrogenated graphene paper bonded by Zn.

FIG. 7 In-plane thermal conductivity values of graphene fluoride paper bonded by Cu.

### DESCRIPTION OF THE PREFERRED EMBODIMENTS

The present disclosure provides a graphene-based paper product having a high through-plane conductivity (also referred to as thickness-direction conductivity) and a process for producing such a product. The paper sheet has a paper sheet plane (x-y plane) and a thickness direction (z-direction) perpendicular to this sheet plane. This disclosure provides a graphene paper product that exhibits both high in-plane (x-y plane) conductivity and high through-plane (thickness-direction or z-direction) conductivity (including both thermal conductivity and electrical conductivity). Both conventional graphene paper and conventional flexible graphite foil always have to compromise the thickness-direction conductivity in order to achieve a high in-plane conductivity, or to sacrifice the in-plane conductivity in order to achieve a high thickness-direction conductivity due to the anisotropic nature of graphene sheets and graphite platelets, respectively. For instance, a graphene film or paper typically exhibits an in-plane thermal conductivity higher than 1,000 W/mK and 1,500 W/mK, respectively, only when the thickness-direction thermal conductivity is lower than 15 W/mK and 8 W/mK, respectively. The present invention has overcome this critical problem in the field of thermal management, enabling fast heat dissipation in all directions, for instance.

The presently invented paper product comprises (i) a sheet or a roll of graphene paper having graphene sheets (having off-plane graphene sheets inclined at an angle of 15-90 degrees relative to the paper sheet plane) and pores between graphene sheets and (ii) a metal that fills in the pores or bonds the graphene sheets together, wherein the graphene sheets contain single-layer or few-layer graphene sheets selected from a pristine graphene material or a non-pristine graphene material, wherein the non-pristine graphene is selected from graphene oxide, reduced graphene oxide, graphene fluoride, graphene chloride, graphene bromide, graphene iodide, hydrogenated graphene, nitrogenated graphene, doped graphene, chemically functionalized graphene, or a combination thereof. The graphene paper product has a through-plane (thickness-direction) thermal conductivity from 10 W/mK to 800 W/mK or a thickness-direction electrical conductivity from 40 S/cm to 3,200 S/cm. These thickness-direction properties are achieved while the corresponding in-plane properties are maintained in the range of 300-1,500 W/mK and 1,200-15,000 S/cm, respectively.

In certain preferred embodiments, the process for producing such a graphene paper product comprises: (a) preparing a graphene dispersion having discrete graphene sheets dispersed in a fluid medium, wherein the graphene sheets contain single-layer or few-layer graphene sheets selected from a pristine graphene material or a non-pristine graphene material, wherein said non-pristine graphene is selected from graphene oxide, reduced graphene oxide, graphene fluoride, graphene chloride, graphene bromide, graphene iodide, hydrogenated graphene, nitrogenated graphene, doped graphene, chemically functionalized graphene, or a combination thereof; (b) assembling the graphene sheets into a sheet or a roll of graphene paper having pores between graphene sheets; and (c) chemically, electrochemically or electrolytically depositing a metal on surfaces of the graphene sheets or into the pores between graphene sheets to bond graphene sheets together for forming the graphene paper product.

Some of the graphene sheets can be arranged to become off-plane, being inclined at an angle with respect to the graphene paper product plane, through several approaches. One is to produce volatile gases during the paper production procedure, forcing some graphene sheets to get oriented along the thickness direction. This can be accomplished by heat-treating graphene paper sheet product containing non-carbon elements (e.g. graphene sheets in the paper contains >10% by weight of O, F, H, N, etc.). This will not be followed by any significant compression action. Alternatively, one may choose to add orientation-controlling solid particles into the graphene paper product.

For instance, the graphene dispersion in step (a) may further contain particles or fibrils of a metal, carbon or graphite filler selected from a carbon or graphite fiber, carbon or graphite nanofiber, carbon nanotube, carbon nanorod, mesophase carbon particle, mesocarbon microbead, expanded graphite flake (having a thickness greater than 100 nm), needle coke, carbon black or acetylene black, activated carbon, or a combination thereof and the metal filler is selected from Ti, V, Cr, Mn, Fe, Co, Ni, Cu, Zn, Zr, Mo, Pd, Ag, Cd, Au, Pt, W, Al, Sn, In, Pb, Bi, an alloy thereof, or a mixture thereof, wherein the filler metal-, carbon-, or graphite-to-graphene ratio is from 1/100 to 1/1. The filler induces orientation of some graphene sheets out of a paper sheet plane (inclined at an angle of 15-90 degrees relative to the paper sheet plane), imparting high through-plane or thickness-direction thermal conductivity and electrical conductivity to the paper product.

Some details about how to prepare graphene dispersion in step (a) of the invented process are presented below. The graphite intercalation compound (GIC) or graphite oxide (GO) may be obtained by immersing powders or filaments of a starting graphitic material in an intercalating/oxidizing liquid medium (e.g. a mixture of sulfuric acid, nitric acid, and potassium permanganate) in a reaction vessel. The starting graphitic material may be selected from natural graphite, artificial graphite, mesophase carbon, mesophase pitch, mesocarbon microbead, soft carbon, hard carbon, coke, carbon fiber, carbon nanofiber, carbon nanotube, or a combination thereof.

When the starting graphite powders or filaments are mixed in the intercalating/oxidizing liquid medium, the resulting slurry is a heterogeneous suspension and appears dark and opaque. When the oxidation of graphite proceeds at a reaction temperature for a sufficient length of time (4-120 hours at room temperature, 20° C.-25° C.), the reacting mass can eventually become a suspension that appears slightly green and yellowish, but remain opaque. If the degree of oxidation is sufficiently high (e.g. having an oxygen content between 20% and 50% by weight, preferably between 30% and 50%) and all the original graphene planes are fully oxidized, exfoliated and separated to the extent that each oxidized graphene plane (now a graphene oxide sheet or molecule) is surrounded by the molecules of the liquid medium, one obtains a GO gel.

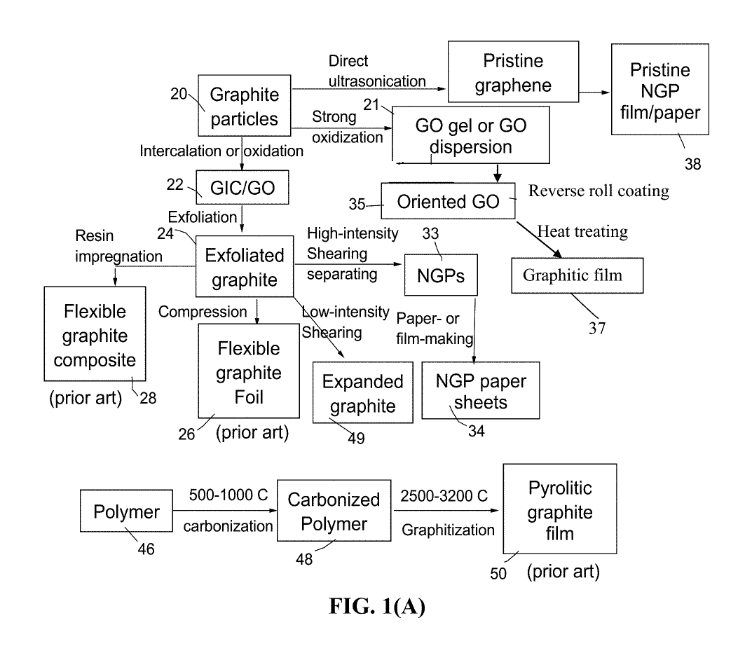

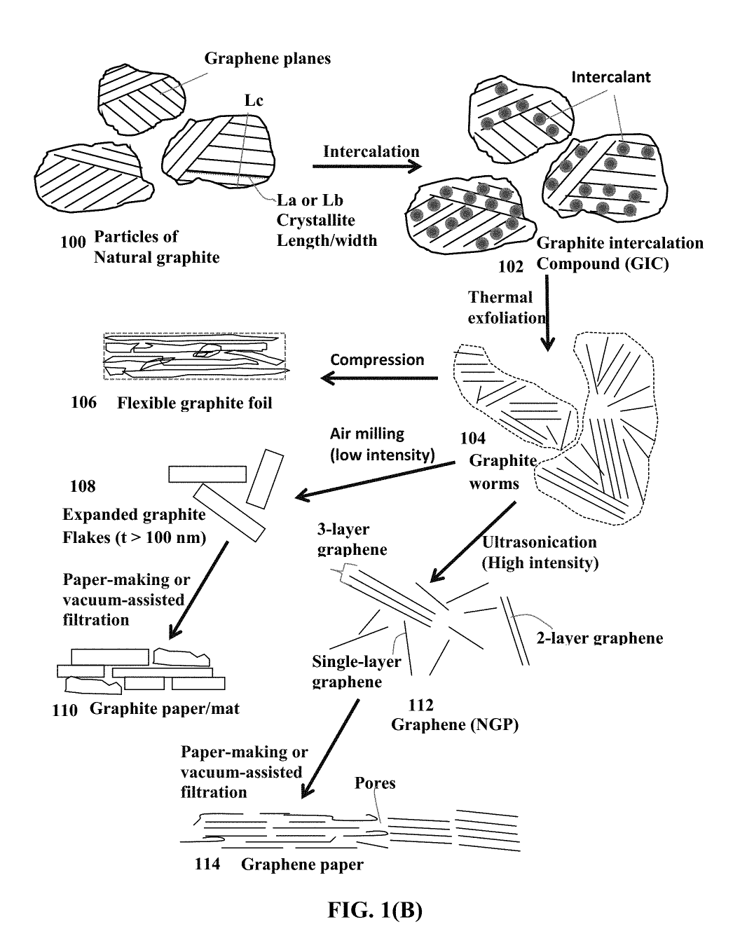

The aforementioned features are further described and explained in detail as follows: As illustrated in FIG. 1(B), a graphite particle (e.g. 100) is typically composed of multiple graphite crystallites or grains. A graphite crystallite is made up of layer planes of hexagonal networks of carbon atoms. These layer planes of hexagonally arranged carbon atoms are substantially flat and are oriented or ordered so as to be substantially parallel and equidistant to one another in a particular crystallite. These layers of hexagonal-structured carbon atoms, commonly referred to as graphene layers or basal planes, are weakly bonded together in their thickness direction (crystallographic c-axis direction) by weak van der Waals forces and groups of these graphene layers are arranged in crystallites. The graphite crystallite structure is usually characterized in terms of two axes or directions: the c-axis direction and the a-axis (or b-axis) direction. The c-axis is the direction perpendicular to the basal planes. The a- or b-axes are the directions parallel to the basal planes (perpendicular to the c-axis direction).

A highly ordered graphite particle can consist of crystallites of a considerable size, having a length of Lₐ along the crystallographic a-axis direction, a width of L_{b} along the crystallographic b-axis direction, and a thickness L_{c} along the crystallographic c-axis direction. The constituent graphene planes of a crystallite are highly aligned or oriented with respect to each other and, hence, these anisotropic structures give rise to many properties that are highly directional. For instance, the thermal and electrical conductivity of a crystallite are of great magnitude along the plane directions (a- or b-axis directions), but relatively low in the perpendicular direction (c-axis). As illustrated in the upper-left portion of FIG. 1(B), different crystallites in a graphite particle are typically oriented in different directions and, hence, a particular property of a multi-crystallite graphite particle is the directional average value of all the constituent crystallites.

Due to the weak van der Waals forces holding the parallel graphene layers, natural graphite can be treated so that the spacing between the graphene layers can be appreciably opened up so as to provide a marked expansion in the c-axis direction, and thus form an expanded graphite structure in which the laminar character of the carbon layers is substantially retained. The process for manufacturing flexible graphite is well-known in the art. In general, flakes of natural graphite (e.g. 100 in FIG. 1(B)) are intercalated in an acid solution to produce graphite intercalation compounds (GICs, 102). The GICs are washed, dried, and then exfoliated by exposure to a high temperature for a short period of time. This causes the flakes to expand or exfoliate in the c-axis direction of the graphite up to 80-300 times of their original dimensions. The exfoliated graphite flakes are vermiform in appearance and, hence, are commonly referred to as worms 104. These worms of graphite flakes which have been greatly expanded can be formed without the use of a binder into cohesive or integrated sheets of expanded graphite, e.g. webs, papers, strips, tapes, foils, mats or the like (typically referred to as “flexible graphite” 106) having a typical density of about 0.04-2.0 g/cm³ for most applications.

The upper left portion of FIG. 1(A) shows a flow chart that illustrates the prior art processes used to fabricate flexible graphite foils and the resin-impregnated flexible graphite composite. The processes typically begin with intercalating graphite particles 20 (e.g., natural graphite or synthetic graphite) with an intercalant (typically a strong acid or acid mixture) to obtain a graphite intercalation compound 22 (GIC). After rinsing in water to remove excess acid, the GIC becomes “expandable graphite.” The GIC or expandable graphite is then exposed to a high temperature environment (e.g., in a tube furnace preset at a temperature in the range of 800° C.-1,050° C.) for a short duration of time (typically from 15 seconds to 2 minutes). This thermal treatment allows the graphite to expand in its c-axis direction by a factor of 30 to several hundreds to obtain a worm-like vermicular structure 24 (graphite worm), which contains exfoliated, but un-separated graphite flakes with large pores interposed between these interconnected flakes.

In one prior art process, the exfoliated graphite (or mass of graphite worms) is re-compressed by using a calendaring or roll-pressing technique to obtain flexible graphite foils (26 in FIG. 1(A) or 106 in FIG. 1(B)), which are typically 100-300 μm thick.

Largely due to the presence of defects, commercially available flexible graphite foils normally have an in-plane electrical conductivity of 1,000-3,000 S/cm, through-plane (thickness-direction or Z-direction) electrical conductivity of 15-30 S/cm, in-plane thermal conductivity of 140-300 W/mK, and through-plane thermal conductivity of approximately 10-30 W/mK. These defects are also responsible for the low mechanical strength (e.g. defects are potential stress concentration sites where cracks are preferentially initiated). These properties are inadequate for many thermal management.

In another prior art process, the exfoliated graphite worm 24 may be impregnated with a resin and then compressed and cured to form a flexible graphite composite 28, which is normally of low strength as well. In addition, upon resin impregnation, the electrical and thermal conductivity of the graphite worms could be reduced by two orders of magnitude.

Alternatively, the exfoliated graphite may be subjected to high-intensity mechanical shearing/separation treatments using a high-intensity air jet mill, high-intensity ball mill, or ultrasonic device to produce separated nano graphene platelets 33 (NGPs) with all the graphene platelets thinner than 100 nm, mostly thinner than 10 nm, and, in many cases, being single-layer graphene (also illustrated as 112 in FIG. 1(B)). An NGP is composed of a graphene sheet or a plurality of graphene sheets with each sheet being a two-dimensional, hexagonal structure of carbon atoms.

Further alternatively, with a low-intensity shearing, graphite worms tend to be separated into the so-called expanded graphite flakes (108 in FIG. 1(B) having a thickness >100 nm. These flakes can be formed into graphite paper or mat 106 using a paper- or mat-making process. This expanded graphite paper or mat 106 is just a simple aggregate or stack of discrete flakes having defects, interruptions, and mis-orientations between these discrete flakes.

For the purpose of defining the geometry and orientation of an NGP, the NGP is described as having a length (the largest dimension), a width (the second largest dimension), and a thickness. The thickness is the smallest dimension, which is no greater than 100 nm, preferably smaller than 10 nm in the present application. When the platelet is approximately circular in shape, the length and width are referred to as diameter. In the presently defined NGPs, both the length and width can be smaller than 1 μm, but can be larger than 200 μm.

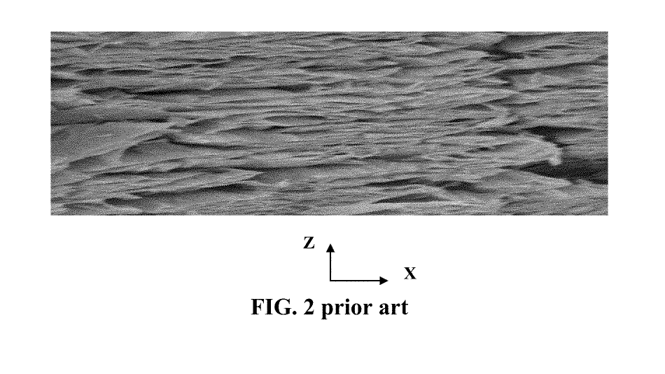

A mass of multiple NGPs (including discrete sheets/platelets of single-layer and/or few-layer graphene or graphene oxide, 33 in FIG. 1(A)) may be readily dispersed in water or a solvent and then made into a graphene paper (34 in FIG. 1(A) or 114 in FIG. 1(B)) using a paper-making process. FIG. 2 shows a SEM image of a cross-section of a graphene paper prepared from discrete graphene sheets using a paper-making process. The image shows the presence of many discrete graphene sheets being folded or interrupted (not integrated), most of platelet orientations being not parallel to the paper surface, the existence of many defects or imperfections.

Fluorinated graphene or graphene fluoride is herein used as an example of the halogenated graphene material group. There are two different approaches that have been followed to produce fluorinated graphene: (1) fluorination of pre-synthesized graphene: This approach entails treating graphene prepared by mechanical exfoliation or by CVD growth with fluorinating agent such as XeF₂, or F-based plasmas; (2) Exfoliation of multilayered graphite fluorides: Both mechanical exfoliation and liquid phase exfoliation of graphite fluoride can be readily accomplished [F. Karlicky, et al. “Halogenated Graphenes: Rapidly Growing Family of Graphene Derivatives” ACS Nano, 2013, 7 (8), pp 6434-6464].

Interaction of F₂ with graphite at high temperature leads to covalent graphite fluorides (CF)ₙ or (C₂F)ₙ, while at low temperatures graphite intercalation compounds (GIC) CₓF (2≤x≤24) form. In (CF)ₙ carbon atoms are sp3-hybridized and thus the fluorocarbon layers are corrugated consisting of trans-linked cyclohexane chairs. In (C₂F)ₙ only half of the C atoms are fluorinated and every pair of the adjacent carbon sheets are linked together by covalent C—C bonds. Systematic studies on the fluorination reaction showed that the resulting F/C ratio is largely dependent on the fluorination temperature, the partial pressure of the fluorine in the fluorinating gas, and physical characteristics of the graphite precursor, including the degree of graphitization, particle size, and specific surface area. In addition to fluorine (F₂), other fluorinating agents may be used, although most of the available literature involves fluorination with F₂ gas, sometimes in presence of fluorides.

For exfoliating a layered precursor material to the state of individual single graphene layers or few-layers, it is necessary to overcome the attractive forces between adjacent layers and to further stabilize the layers. This may be achieved by either covalent modification of the graphene surface by functional groups or by non-covalent modification using specific solvents, surfactants, polymers, or donor-acceptor aromatic molecules. The process of liquid phase exfoliation includes ultra-sonic treatment of a graphite fluoride in a liquid medium to produce graphene fluoride sheets dispersed in the liquid medium. The resulting dispersion can be directly made into a sheet of paper or a roll of paper.

The nitrogenation of graphene can be conducted by exposing a graphene material, such as graphene oxide, to ammonia at high temperatures (200° C.-400° C.). Nitrogenated graphene could also be formed at lower temperatures by a hydrothermal method; e.g. by sealing GO and ammonia in an autoclave and then increased the temperature to 150° C.-250° C. Other methods to synthesize nitrogen doped graphene include nitrogen plasma treatment on graphene, arc-discharge between graphite electrodes in the presence of ammonia, ammonolysis of graphene oxide under CVD conditions, and hydrothermal treatment of graphene oxide and urea at different temperatures.

For the purpose of defining the claims of the instant application, NGPs or graphene materials include discrete sheets/platelets of single-layer and multi-layer (typically less than 10 layers, the few-layer graphene) pristine graphene, graphene oxide, reduced graphene oxide (RGO), graphene fluoride, graphene chloride, graphene bromide, graphene iodide, hydrogenated graphene, nitrogenated graphene, chemically functionalized graphene, doped graphene (e.g. doped by B or N). Pristine graphene has essentially 0% oxygen. RGO typically has an oxygen content of 0.001%-5% by weight. Graphene oxide (including RGO) can have 0.001%-50% by weight of oxygen. Other than pristine graphene, all the graphene materials have 0.001%-50% by weight of non-carbon elements (e.g. O, H, N, B, F, Cl, Br, I, etc.). These materials are herein referred to as non-pristine graphene materials. The presently invented graphene-carbon foam can contain pristine or non-pristine graphene and the invented method allows for this flexibility.

For step (c) of the presently invented process, a bonding metal may be implemented into small gaps in the graphene paper to bond the un-connected graphene sheets in the graphitic layer at least in an end-to-end manner. The metal may also fill into pores of the graphene paper to bridge the interruptions of electron and phonon transport pathways.

The bonding metal may be selected from Ti, V, Cr, Mn, Fe, Co, Ni, Cu, Zn, Zr, Mo, Pd, Ag, Cd, Au, Pt, W, Al, Sn, In, Pb, Bi, an alloy thereof, or a mixture thereof. Any transition metal can be used, but preferably, the bonding metal is selected from Cu, Al, Ti, Sn, Ag, Au, Fe, or an alloy thereof.

The step of depositing a bonding metal onto graphene sheet surfaces or between graphene sheets is preferably conducted chemically, electrochemically or electrolytically. The step of impregnating the porous graphitic film with a metal or metal alloy can include an operation of electrochemical deposition or plating, pulse power deposition, solution impregnation, electrophoretic deposition, electroless plating or deposition, metal melt impregnation, metal precursor impregnation, chemical deposition, physical vapor deposition, physical vapor infiltration, chemical vapor deposition, chemical vapor infiltration, sputtering, or a combination thereof. These individual operations per se are well-known in the art. For instance, for electrochemical deposition, one may impose a DC current by connecting the porous graphitic film to one terminal (e.g. negative electrode) and a piece of the desired metal (e.g. Cu, Zn, or Ni) to the opposite terminal (e.g. positive electrode) in an electrochemical chamber (e.g. just a simple bath containing an electrolyte).

### Example 1: Preparation of Discrete Graphene Oxide (GO) Sheets

Chopped graphite fibers with an average diameter of 12 μm and natural graphite particles were separately used as a starting material, which was immersed in a mixture of concentrated sulfuric acid, nitric acid, and potassium permanganate (as the chemical intercalate and oxidizer) to prepare graphite intercalation compounds (GICs). The starting material was first dried in a vacuum oven for 24 h at 80° C. Then, a mixture of concentrated sulfuric acid, fuming nitric acid, and potassium permanganate (at a weight ratio of 4:1:0.05) was slowly added, under appropriate cooling and stirring, to a three-neck flask containing fiber segments. After 5-16 hours of reaction, the acid-treated graphite fibers or natural graphite particles were filtered and washed thoroughly with deionized water until the pH level of the solution reached 6. After being dried at 100° C. overnight, the resulting graphite intercalation compound (GIC) or graphite oxide fiber was re-dispersed in water and/or alcohol to form a slurry.

In one sample, 500 grams of the graphite oxide fibers were mixed with 2,000 ml alcohol solution consisting of alcohol and distilled water with a ratio of 15:85 to obtain a slurry mass. Then, the mixture slurry was subjected to ultrasonic irradiation with a power of 200 W for various lengths of time. After 20 minutes of sonication, GO fibers were effectively exfoliated and separated into thin graphene oxide sheets with oxygen content of approximately 23%-31% by weight.

A paper-making process (vacuum-assisted filtration) was then followed to make the resulting suspension into several sheets of GO paper (1, 10, 50, 100, and 500 μm in thickness) on a glass plate surface. For making graphene paper products, various GO products were subjected to heat treatments that typically involve an initial thermal reduction temperature of 80° C.-1,500° C. for 1-8 hours to obtain reduced graphene oxide (RGO) paper products, optionally followed by heat-treating at a final heat treatment temperature (HTT) of 1,500° C.-3,000° C. Several paper products were then subjected to electro-plating treatments that deposit Cu to bond RGO sheets together; others were without such a bonding metal.

### Example 2: Preparation of Single-Layer Graphene Sheets from Mesocarbon Microbeads (MCMBs)

Mesocarbon microbeads (MCMBs) were supplied from China Steel Chemical Co., Kaohsiung, Taiwan. This material has a density of about 2.24 g/cm³ with a median particle size of about 16 μm. MCMB (10 grams) were intercalated with an acid solution (sulfuric acid, nitric acid, and potassium permanganate at a ratio of 4:1:0.05) for 48-96 hours. Upon completion of the reaction, the mixture was poured into deionized water and filtered. The intercalated MCMBs were repeatedly washed in a 5% solution of HCl to remove most of the sulfate ions. The sample was then washed repeatedly with deionized water until the pH of the filtrate was no less than 4.5. The slurry was then subjected ultrasonication for 10-100 minutes to produce GO suspensions. TEM and atomic force microscopic studies indicate that most of the GO sheets were single-layer graphene when the oxidation treatment exceeded 72 hours, and 2- or 3-layer graphene when the oxidation time was from 48 to 72 hours.

The GO-water suspension was then made into GO paper sheets, having a thickness from approximately 0.5 μm to 500 μm. The GO paper sheets were then subjected to heat treatments that involved an initial thermal reduction temperature of 80° C.-500° C. for 1-5 hours, optionally followed by heat-treating at a second temperature of 1,000° C.-2,850° C. Several paper products were then subjected to electro-plating treatments that deposit Ni to bond RGO sheets together; others were without such a bonding metal.

### Example 3: Preparation of Metal Bonded Pristine Graphene Paper

Pristine graphene sheets were produced by using the direct ultrasonication or liquid-phase exfoliation process. In a typical procedure, five grams of graphite flakes, ground to approximately 20 μm in sizes, were dispersed in 1,000 mL of deionized water (containing 0.1% by weight of a dispersing agent, Zonyl® FSO from DuPont) to obtain a suspension. An ultrasonic energy level of 85 W (Branson S450 Ultrasonicator) was used for exfoliation, separation, and size reduction of graphene sheets for a period of 15 minutes to 2 hours. The resulting graphene sheets were pristine graphene that had never been oxidized and were oxygen-free and relatively defect-free. There are substantially no other non-carbon elements. Several different types of graphene sheet-orienting fillers were separately added into samples of graphene-water suspension to make slurry samples, which were made into paper sheets. These fillers include vapor-grown carbon nanofibers (VG-CNF), carbon black particles, chopped graphite fiber segments, ultrasonically cut carbon nanotubes, etc. Upon completion of the paper-making procedure, some of the samples were compressed to a controlled extent to produce paper sheet products having different extents of off-plane graphene sheet orientation to achieve a balance of in-plane and through-plane conductivities (before or after metal deposition).

### Example 4: Preparation of Metal-Bonded Graphene Fluoride (GF) Paper

Several processes have been used by us to produce GF, but only one process is herein described as an example. In a typical procedure, highly exfoliated graphite (HEG) was prepared from intercalated compound C₂F.xClF₃. HEG was further fluorinated by vapors of chlorine trifluoride to yield fluorinated highly exfoliated graphite (FHEG). A pre-cooled Teflon reactor was filled with 20-30 mL of liquid pre-cooled ClF₃, and then the reactor was closed and cooled to liquid nitrogen temperature. Subsequently, no more than 1 g of HEG was put in a container with holes for ClF₃ gas to access the reactor. After 7-10 days, a gray-beige product with approximate formula C₂F was formed. GF sheets were then dispersed in halogenated solvents to form suspensions and made into paper sheet products using the vacuum-assisted paper-making procedure. This was followed by a heat treatment at 500° C. for 2 hours and electrochemical deposition of Cu or Ni.

### Example 5: Preparation of Metal Bonded Nitrogenated Graphene Paper

Graphene oxide (GO), synthesized in Example 2, was finely ground with different proportions of urea and the pelletized mixture heated in a microwave reactor (900 W) for 30 s. The product was washed several times with deionized water and vacuum dried. In this method graphene oxide gets simultaneously reduced and doped with nitrogen. The products obtained with graphene/urea mass ratios of 1/0.5, 1/1 and 1/2 are designated as N-1, N-2 and N-3 respectively and the nitrogen contents of these samples were 14.7, 18.2 and 17.5 wt. % respectively as determined by elemental analysis. These nitrogenated graphene sheets remain dispersible in water. The slurry was then made into paper sheet products.

### Example 6: Additional Details on Preparation of Conductive Paper Products Composed of Metal-Bonded Graphene Sheets Having Some Off-Plane Graphene Sheets

Several procedures were used to impregnate metal into the pores of porous graphene paper products prepared according to the procedures described above: electrochemical deposition or plating, pulse power deposition, electrophoretic deposition, electroless plating or deposition, metal melt impregnation (more convenient for lower-melting metals, such as Zn and Sn), metal precursor impregnation (impregnation of metal precursor followed by chemical or thermal conversion of precursor to metal), physical vapor deposition, physical vapor infiltration, chemical vapor deposition, chemical vapor infiltration, and sputtering.

For instance, purified zinc sulfate (ZnSO₄) is a precursor to Zn; zinc sulfate was impregnated into the pores of several paper products via solution impregnation and then converted into Zn via electrolysis. In this procedure zinc sulfate solution was used as electrolyte in a tank containing a lead anode and graphene paper cathode. Current was passed between the anode and cathode and metallic zinc was plated onto the cathodes (onto graphene surfaces and between graphene sheets) by a reduction reaction.

Pure metallic Cu was synthesized (inside pores of graphene paper) by the reduction of cupric chloride with hydrazine in the aqueous CTAB solution. The use of ammonia solution for the adjustment of solution pH up to 10 and the use of hydrazine as a reducing agent in a capped reaction chamber are crucial for the synthesis of pure Cu. The reaction solution finally became wine-reddish and its UV/vis absorption spectrum exhibited an absorption band at 574 nm, revealing the formation of metallic Cu.

Cu infiltration and deposition could also be achieved with the chemical vapor deposition method using [Cu(OOCC2F5)(L)], L=vinyltrimethylsilane or vinyltriethylsilane as a precursor at a temperature of 400° C.-700° C. The precursor Cu complexes were carried out using a standard Schlenk technique under the Ar atmosphere.

As an example of higher melting point metal, precursor infiltration and chemical conversion could be used to obtain metal impregnation. For instance, the hydrogenolysis of nickelocene can occur through a self-catalyzed process at low temperature (<70° C.) in supercritical carbon dioxide to generate relatively uniform dispersed Ni metal film or particles in the pores of graphene paper. Nickelocene (NiCp₂) was used as the precursor and H₂ was used as the reducing agent. Coleman-grade CO₂ and high-purity H₂ were used without further purification. The experiment was carried out in a high-pressure reactor (autoclave).

In a typical experiment, 70-90 mg NiCp₂ was loaded into the high-pressure reactor. Following precursor loading, low-pressure fresh CO₂ was used to purge the system for 10 min at 70° C. in order to purge air out of the reactor. After purging, high-pressure CO₂ was fed into the reactor through a high-pressure syringe pump. The temperature of the supercritical (sc) CO₂ solution was stabilized by a heating tape at the dissolving condition (T=70° C., P=17 MPa) for 4 h to form a uniform solution. During NiCp₂ dissolution, H₂ was fed into another clean, air-free high-pressure manifold vessel at a pressure of 3.5 MPa at 60° C. The vessel was then further charged with fresh CO₂ using the high-pressure syringe pump to a pressure of 34.5 MPa. This H₂/scCO₂ solution was kept stable at this condition for more than 2 h before being injected into the high-pressure reactor. Upon H₂/scCO₂ injection, the pressure in the vessel dropped from 34.5 to 13 MPa, allowing the amount of H₂ fed into the reactor to be quantified. The H₂ injection process was repeated to obtain a 50-100 molar excess of hydrogen relative to nickelocene in the reactor system. Upon addition of H₂, the scCO₂ solution containing NiCp₂ maintained a green color and the reaction system was left undisturbed at 70° C., 17 MPa for 7-8 hours. After 7-8 h substantial Ni film deposition in the pores of graphene paper was obtained.

We have found that Zn (melting point=419.5° C.) and Sn (MP=231.9° C.) in the molten state readily permeate into pores or gaps (between graphene sheets) of the porous graphene paper. Other metals were readily deposited using electrochemical plating or electroless plating, etc.

### Example 7: Electric and Thermal Conductivities of Metal-Bonded Graphene Paper Products

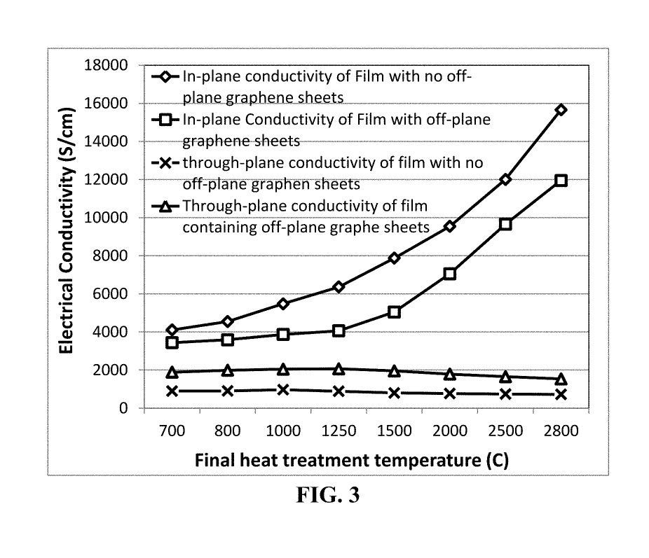

FIG. 3 shows the in-plane and through-plane electrical conductivity values of the GO-derived graphene sheets bonded with Cu, plotted as a function of the final heat treatment temperature (prepared by Comma coating, heat treatment, and compression), with or without off-plane graphene sheets. All these graphene paper sheets are bonded with 10% Cu.

With some off-plane graphene sheets, the electrical conductivity of the Cu-bonded graphene sheets is slightly reduced (by an average of 30%), but remains relatively high. However, the through-plane or thickness-direction conductivity is almost doubled.

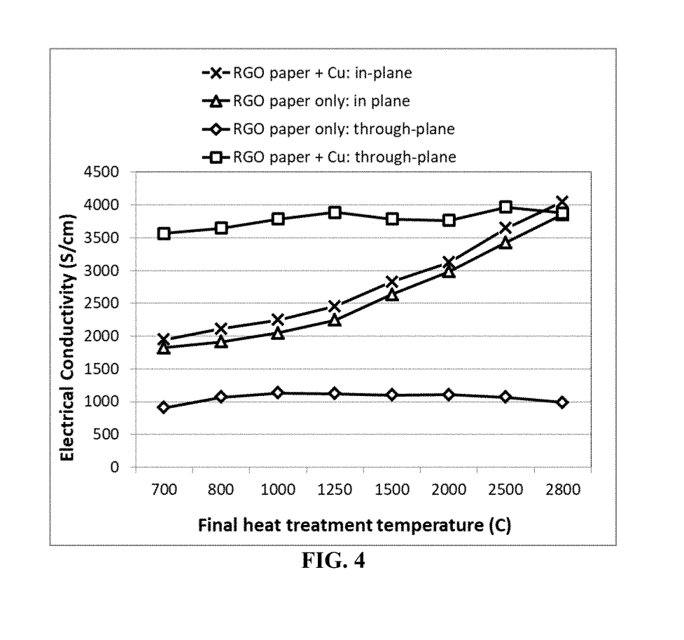

All the prior art work on the preparation of paper or membrane from pristine graphene or graphene oxide sheets/platelets follows distinctly different processing paths, leading to a simple aggregate or stack of discrete graphene/GO/RGO platelets. These simple aggregates or stacks exhibit many folded graphite flakes, kinks, gaps, and mis-orientations, resulting in poor thermal conductivity, low electrical conductivity, and weak mechanical strength. However, the presence of a bonding metal overcomes this issue and the presence of off-plane graphene sheets imparts a significantly higher thickness-direction conductivity. This is demonstrated in FIG. 4, which shows the in-plane and through-plane electrical conductivity values of RGO paper sheets (all having some intentionally produced off-plane graphene sheets), with or without bonding Cu.

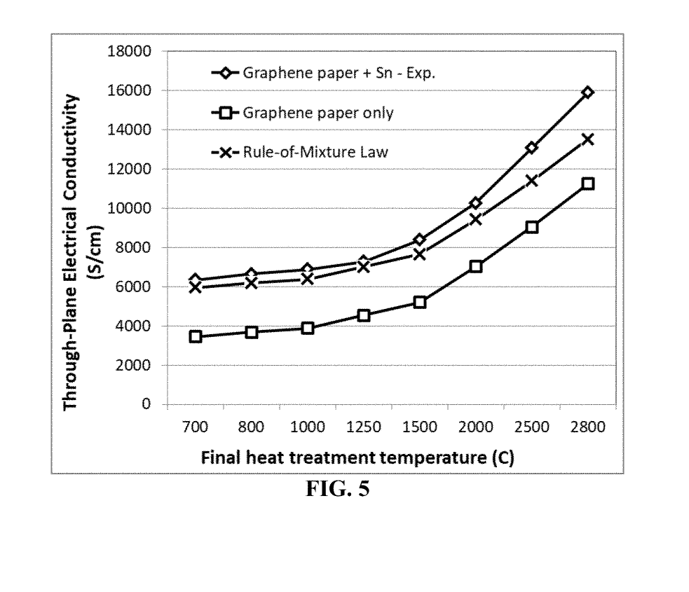

Similar synergistic effects are observed with metal-bonded graphene based membranes. For instance, FIG. 5 shows the electrical conductivity values of the GO-derived graphene membrane, similarly made graphene membrane having graphene sheets bonded by 3% Sn (experimental values), and values based on rule-of-mixture law prediction, all plotted as a function of the final heat treatment temperature. The experimental values are all significantly higher than the values based on the rule-of-mixture law prediction.

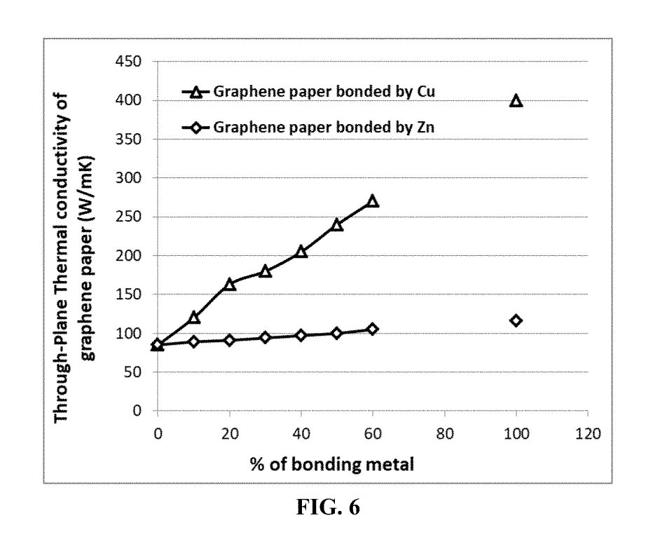

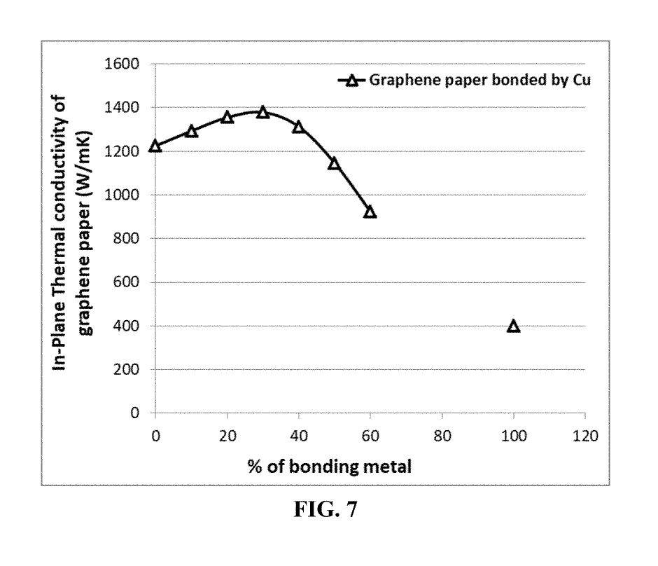

Shown in FIG. 6 are through-plane thermal conductivity values of graphene fluoride paper bonded by Cu and those of nitrogenated graphene paper bonded by Zn. With some off-plane graphene sheets and bonding metal (e.g. Cu), a thickness-direction thermal conductivity as high as 280 W/mK was readily achieved. FIG. 7 shows that the in-plane thermal conductivity values of graphene fluoride paper bonded by Cu remain relatively high even though a high through-plane thermal conductivity has been achieved.

By increasing the proportion of off-plane or thickness-direction graphene sheets that are bonded by Cu, one could obtain a thickness-direction thermal conductivity as high as 800 W/mK.

We claim:

1. A process for producing a graphene paper product of metal-bonded graphene sheets, said process comprising:
(a) preparing a graphene dispersion having discrete graphene sheets dispersed in a fluid medium, wherein said graphene sheets contain single-layer or few-layer graphene sheets selected from a pristine graphene material or a non-pristine graphene material, wherein said non-pristine graphene is selected from graphene oxide, reduced graphene oxide, graphene fluoride, graphene chloride, graphene bromide, graphene iodide, hydrogenated graphene, nitrogenated graphene, doped graphene, chemically functionalized graphene, or a combination thereof;
(b) assembling said graphene sheets into a sheet or a roll of graphene paper having a paper sheet plane, a thickness direction perpendicular to said paper sheet plane, multiple pores between graphene sheets and a number of graphene sheets being inclined at an angle of 15-90 degrees relative to said paper sheet plane; and
(c) depositing a bonding metal on surfaces of said graphene sheets or into said pores between graphene sheets to bond graphene sheets together for forming said graphene paper product.

2. The process of claim 1, wherein said step of depositing a bonding metal includes chemical deposition, including electroless plating, electrochemical deposition, including electro-plating, electrolytical deposition, or a combination thereof.

3. The process of claim 1, wherein said graphene paper product has a through-plane or thickness-direction thermal conductivity from 10 to 800 W/mK or a thickness-direction electrical conductivity from 40 S/cm to 3,200 S/cm.

4. The process of claim 1, further comprising, after step (c), a step (d) of mechanically compressing or consolidating said graphene paper product.

5. The process of claim 1, wherein said graphene dispersion contains particles or fibrils of a metal, carbon or graphite filler to induce orientation of said graphene sheets inclined at an angle of 15-90 degrees relative to said paper sheet plane, wherein said carbon or graphite filler is selected from a carbon or graphite fiber, carbon or graphite nanofiber, carbon nanotube, carbon nanorod, mesophase carbon particle, mesocarbon microbead, expanded graphite flake, needle coke, carbon black or acetylene black, activated carbon, or a combination thereof, and said metal filler is selected from Ti, V, Cr, Mn, Fe, Co, Ni, Cu, Zn, Zr, Mo, Pd, Ag, Cd, Au, Pt, W, Al, Sn, In, Pb, Bi, an alloy thereof, or a mixture thereof and wherein said metal-, carbon-, or graphite-to-graphene ratio is from 1/100 to 1/1.

6. The process of claim 1, wherein said bonding metal is selected from Ti, V, Cr, Mn, Fe, Co, Ni, Cu, Zn, Zr, Mo, Pd, Ag, Cd, Au, Pt, W, Al, Sn, In, Pb, Bi, an alloy thereof, or a mixture thereof.

7. The process of claim 1, wherein said metal occupies a weight fraction of 0.1%-95% based on the total paper product weight.

8. The process of claim 1, wherein said metal occupies a weight fraction of 1%-50% based on the total paper product weight.

9. The process of claim 1, wherein said metal bonds said graphene sheets at least in an end-to-end manner, or said metal fills into pores of said paper product.

10. The process of claim 1, wherein said step (b) includes a heat treatment at a temperature from 80° C. to 1,500° C. to at least partially remove non-carbon elements in said graphene sheets, wherein removal of said non-carbon elements induces orientation of graphene sheets out of a paper sheet plane which are inclined at an angle of 15-90 degrees relative to said paper sheet plane.

11. The process of claim 10, wherein said heat treatment temperature contains a temperature from 500° C. to 1,500° C. and the graphene paper product has a thickness-direction thermal conductivity from 20 W/mK to 800 W/mK or a thickness-direction electrical conductivity from 80 S/cm to 3,200 S/cm.

12. A process for producing a graphene paper product having a high thickness-direction conductivity, said process comprising: (a) preparing a graphene dispersion having discrete graphene sheets dispersed in a fluid medium, wherein said graphene sheets contain single-layer or few-layer graphene sheets selected from a pristine graphene material or a non-pristine graphene material, wherein said non-pristine graphene is selected from graphene oxide, reduced graphene oxide, graphene fluoride, graphene chloride, graphene bromide, graphene iodide, hydrogenated graphene, nitrogenated graphene, doped graphene, chemically functionalized graphene, or a combination thereof; and (b) assembling said graphene sheets into a sheet or a roll of graphene paper, having a paper sheet plane and a thickness direction perpendicular to said paper sheet plane, and heat treating said sheet or roll of graphene paper at a first temperature from 80° C. to 1,500° C. to at least partially remove non-carbon elements in said graphene sheets, wherein removal of said non-carbon elements induces orientation of graphene sheets out of a paper sheet plane which are inclined at an angle of 15-90 degrees relative to said paper sheet plane in such a manner that the graphene paper product has a thickness-direction thermal conductivity from 10 to 200 W/mK or a thickness-direction electrical conductivity from 40 S/cm to 800 S/cm.

13. The process of claim 12, further comprising a step of heat treating the sheet or roll of graphene paper at a second temperature from 1,500° C. to 3,200° C.

14. The process of claim 12, wherein said graphene dispersion contains particles or fibrils of a metal, carbon or graphite filler to induce orientation of said graphene sheets inclined at an angle of 15-90 degrees relative to said paper sheet plane, wherein said carbon or graphite filler is selected from a carbon or graphite fiber, carbon or graphite nanofiber, carbon nanotube, carbon nanorod, mesophase carbon particle, mesocarbon microbead, expanded graphite flake, needle coke, carbon black or acetylene black, activated carbon, or a combination thereof, and said metal filler is selected from Ti, V, Cr, Mn, Fe, Co, Ni, Cu, Zn, Zr, Mo, Pd, Ag, Cd, Au, Pt, W, Al, Sn, In, Pb, Bi, an alloy thereof, or a mixture thereof and wherein said metal-, carbon-, or graphite-to-graphene ratio is from 1/100 to 1/1.

15. The process of claim 1, wherein said step of depositing said includes an operation of electrochemical plating, pulse power deposition, solution deposition, electrophoretic deposition, electroless plating, chemical deposition, or a combination thereof.

16. The process of claim 1, wherein said graphene sheets in said graphene dispersion occupy a weight fraction of 0.1% to 25% based on the total weight of graphene sheets and liquid medium combined.

17. The process of claim 1, wherein said graphene dispersion has greater than 3% by weight of graphene or graphene oxide sheets dispersed in said fluid medium to form a liquid crystal phase.

18. The process of claim 1, wherein said graphene paper product has a thickness from 10 nm to 500 μm.

19. A graphene paper product of metal-bonded graphene sheets produced by a process as defined in claim 1, wherein said paper product comprises (i) a sheet or a roll of graphene paper having graphene sheets and pores between graphene sheets and (ii) a metal that fills in said pores and bonds said graphene sheets together, wherein said graphene sheets contain single-layer or few-layer graphene sheets selected from a pristine graphene material or a non-pristine graphene material, wherein said non-pristine graphene is selected from graphene oxide, reduced graphene oxide, graphene fluoride, graphene chloride, graphene bromide, graphene iodide, hydrogenated graphene, nitrogenated graphene, doped graphene, chemically functionalized graphene, or a combination thereof and said graphene paper product has a number of graphene sheets oriented at an angle of 15-90 degrees relative to a graphene paper sheet plane and a thickness-direction thermal conductivity from 10 W/mK to 800 W/mK or a thickness-direction electrical conductivity from 40 S/cm to 3,200 S/cm.

20. A graphene paper product produced by a process as defined in claim 12, wherein said paper product comprises a sheet or a roll of graphene paper having graphene sheets, wherein said graphene sheets contain single-layer or few-layer graphene sheets selected from a pristine graphene material or a non-pristine graphene material, wherein said non-pristine graphene is selected from graphene oxide, reduced graphene oxide, graphene fluoride, graphene chloride, graphene bromide, graphene iodide, hydrogenated graphene, nitrogenated graphene, doped graphene, chemically functionalized graphene, or a combination thereof and said graphene paper product has a number of graphene sheets oriented at an angle of 15-90 degrees relative to a graphene paper sheet plane and a thickness-direction thermal conductivity from 10 W/mK to 200 W/mK or a thickness-direction electrical conductivity from 40 S/cm to 800 S/cm.

21. The graphene paper product of claim 19, further comprising particles or fibrils of a carbon or graphite filler disposed between graphene sheets and selected from a carbon or graphite fiber, carbon or graphite nanofiber, carbon nanotube, carbon nanorod, mesophase carbon particle, mesocarbon microbead, expanded graphite flake (having a thickness greater than 100 nm), needle coke, carbon black or acetylene black, activated carbon, or a combination thereof, wherein said carbon or graphite-to-graphene ratio is from 1/100 to 1/1

22. A thermal management system comprising the graphene paper product of claim 19 as a heat spreader or thermal interface material.

23. A heat dissipation or heat spreading element containing said graphene paper product of claim 20, wherein said element is disposed in a smart phone, tablet computer, digital camera, display device, flat-panel TV, or LED lighting device.

24. A fuel cell bipolar plate containing the graphene paper product of claim 19.

25. A battery current collector containing the graphene paper product of claim 19.

26. The graphene paper product of claim 20, further comprising particles or fibrils of a carbon or graphite filler disposed between graphene sheets and selected from a carbon or graphite fiber, carbon or graphite nanofiber, carbon nanotube, carbon nanorod, mesophase carbon particle, mesocarbon microbead, expanded graphite flake (having a thickness greater than 100 nm), needle coke, carbon black or acetylene black, activated carbon, or a combination thereof, wherein said carbon or graphite-to-graphene ratio is from 1/100 to 1/1

27. A thermal management system comprising the graphene paper product of claim 20 as a heat spreader or thermal interface material.

28. A fuel cell bipolar plate containing the graphene paper product of claim 20.

29. A battery current collector containing the graphene paper product of claim 20.
